(19) United States
(12) Patent Application Publication
(10) Pub. No.: US 2021/0012299 A1
(43) Pub. Date: Jan. 14, 2021

(54) System and Method of Paying off Debt through a Lottery

(71) Applicant: VICTOR OLAYINKA OLAOGUN, ATLANTA, GA (US)

(72) Inventor: VICTOR OLAYINKA OLAOGUN, ATLANTA, GA (US)

(21) Appl. No.: 16/924,652

(22) Filed: Jul. 9, 2020

Related U.S. Application Data
(60) Provisional application No. 62/872,041, filed on Jul. 9, 2019.

(51) Int. Cl. G06Q 20/10; G06Q 20/02; G07F 17/32

(52) U.S. Cl. CPC G06Q 20/102; G07F 17/329; G07F 17/3244; G06Q 20/02

(57) ABSTRACT

A method of paying off debt through a lottery provides a chance for individuals to reduce a significant amount of debt or all debt. The method includes at least one remote server and a user personal computing (PC) device. A plurality of user accounts and a plurality of virtual lotteries are managed by the remote server. The method begins by enabling each user account to navigate through a lottery debt type and a lottery debt tier with a user PC device. Each user account is then prompted to purchase at least one ticket for at least one desired lottery with the user PC device. The ticket is relayed from the user PC device to the remote server. A winner for each virtual lottery is randomly selected with the remote server. A winning amount for the desired lottery is financially transferred to the debtor information of the winning user account.

The current application claims a priority to the U.S. provisional patent application Ser. No. 62/872,041 filed on Jul. 9, 2019.

### FIELD OF THE INVENTION

The present invention generally relates to lotteries. More specifically, the present invention pays off debt through a lottery.

### BACKGROUND OF THE INVENTION

Household debt is on the rise in many countries, and this is because the standard of living is increasing faster than the accumulation of disposable income. People are also easily exposed to high-end products and services with advancements in technology and the popularity of social media. These people are therefore compelled by various factors to purchase these high-end products and services on credit. There are also necessary purchases and investments needed in a household such as a house, a car, an education, and so on. These expenses also cost a lot of money and further limit the accumulation of disposable income. Household debt has become an increasingly heavy burden on most families in many countries, leading many to default as a result of job loss, divorce, family death, health complications, and so on.

It is therefore an objective of the present invention to provide a solution whereby individuals are able to pay off pay a significant portion of a debt by playing the lottery. The present invention gives individuals a chance to be relieved of debt burdens. The present invention directly pays off any debt of an individual through a corresponding creditor. The present invention also increases the chances of the paying off debts by grouping debts based on types of debt and amounts of debt. The present invention allows an individual to increase individual chances of winning by purchasing as many desired tickets for a specific lottery as desired. Moreover, the present invention allows a user to better manage multiple debts simultaneously.

### BRIEF DESCRIPTION OF THE DRAWINGS

FIG. 1 is a diagram illustrating a system of the present invention.

FIG. 2 is a flowchart illustrating the overall process for a method of the present invention.

FIG. 3 is a flowchart illustrating a continuation of the flowchart in FIG. 1.

FIG. 4 is a flowchart illustrating the subprocess for determining an applicable portion and a remainder portion of a pot for a desired lottery.

FIG. 5 is a flowchart illustrating the subprocess for designating the applicable portion of the desired lottery as a winning amount for the desired lottery.

FIG. 6 is a flowchart illustrating the subprocess for reallocating a transferable portion of the applicable portion of the desired lottery into the pot of a lower-tiered lottery.

FIG. 7 is a flowchart illustrating the subprocess for distributing the transferrable portion into the pot of each lower-tiered lottery in accordance with a reallocation percentage.

FIG. 8 is a flowchart illustrating the subprocess for reallocating the transferable portion of the desired lottery into a pot of a cash lottery.

FIG. 9 is a flowchart illustrating the subprocess for financially transferring the remainder portion of the desired lottery to an administrator account.

FIG. 10 is a flowchart illustrating the subprocess for outputting a specific ticket number of a ticket of the desired lottery with a corresponding user PC device.

FIG. 11 is a flowchart illustrating the subprocess for financially transferring a full portion of the winning amount for the desired lottery to the debtor information of an arbitrary user account.

FIG. 12 is a flowchart illustrating the subprocess for executing an electronic transfer for the full portion from the administrator account to the debtor information.

FIG. 13 is a flowchart illustrating the subprocess for generating a payment note for the full portion.

FIG. 14 is a flowchart illustrating the subprocess for financially transferring the leftover portion of the wining amount for the desired lottery only if a debt owed amount is less than the winning amount.

FIG. 15 is a flowchart illustrating the subprocess for executing an electronic transfer for the partial portion from the administrator account to the debtor information.

FIG. 16 is a flowchart illustrating the subprocess for generating a payment note for the partial portion.

FIG. 17 is a flowchart illustrating the subprocess for compiling a first debt profile and a second debt profile into a single debt profile.

FIG. 18 is a flowchart illustrating the subprocess for randomly selecting a winner for at least one specific lottery if the current number of purchased tickets is greater than or equal to a threshold for the purchased tickets.

FIG. 19 is a flowchart illustrating the subprocess for executing a financial purchase of a ticket for the desired lottery between an arbitrary user account and a third-part account and outputting a purchase confirmation.

### DETAIL DESCRIPTIONS OF THE INVENTION

All illustrations of the drawings are for the purpose of describing selected versions of the present invention and are not intended to limit the scope of the present invention.

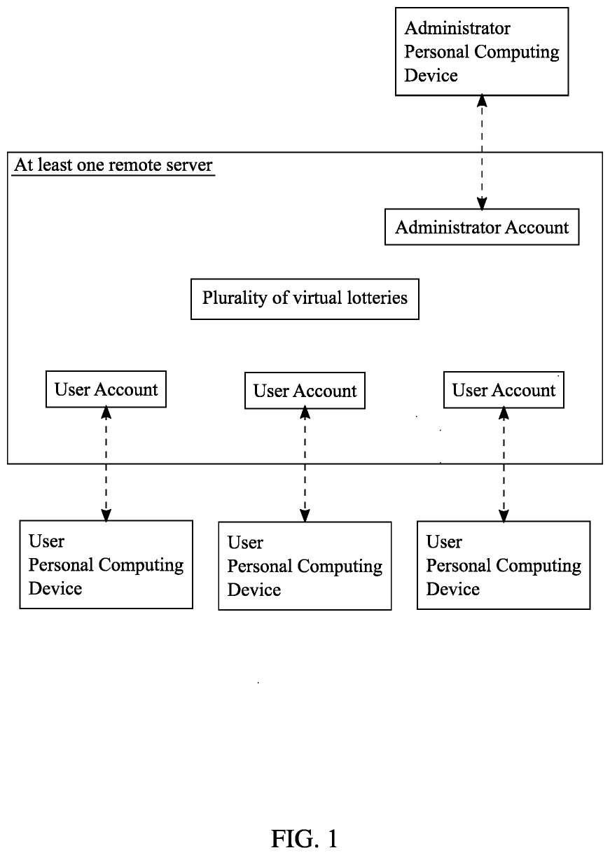

The present invention is a system and method of paying off debt through a lottery. Thus, the physical system used to implement the method for the present invention includes at least one remote server and a corresponding user personal computing (PC) device. A plurality of user accounts is managed by the at least one remote server, wherein each user account is associated with a corresponding user PC device (Step A), as seen in FIG. 1. Any data associated with the plurality of user accounts is stored on the at least one remote server. More specifically, each user account includes at least one debt profile, and the debt profile includes a debtor information, a personal debt type, and a personal debt amount. The debt profile is any amount of money due to a creditor, such as a bank, a lessor, an educational institution, a credit card company, a car finance company, a hospital, and so on. The debtor information provides identification information of a debtor and any account information that is designated to receive payments. Moreover, a debtor can be, but is not limited to, an individual, a couple of company partners, or a corporate entity. The personal debt type specifies the type of debt owed to the creditor. The types of debt can be, but are not limited to, a loan, a balance, a medical bill, or a utility bill. The personal debt amount is the total amount of money owed by the debtor. A user PC device is preferably a smart phone. However, a user PC device can alternatively be, but is not limited to, a laptop, a tablet, a smart watch, or a desktop. Furthermore, a plurality of virtual lotteries is provided and is managed by the remote server (Step B). The plurality of virtual lotteries provides a chance for each user account to pay off a personal debt amount. In order to provide equal chances of winning the virtual lottery, each virtual lottery includes a lottery debt type, such as a credit card debt, a car loan debt, a student loan debt, and a mortgage loan debt, and a lottery debt tier, which is a range of debt amounts wherein each personal debt amount falls within a lottery debt tier.

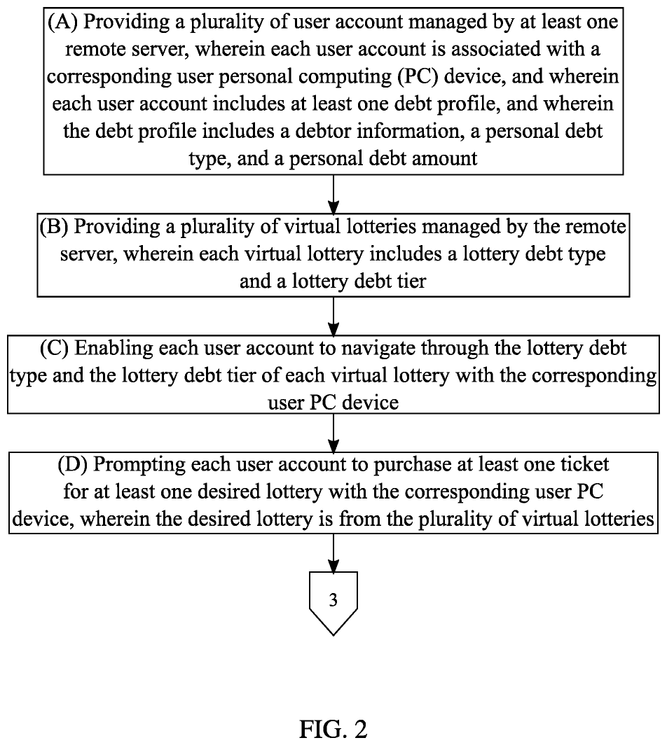

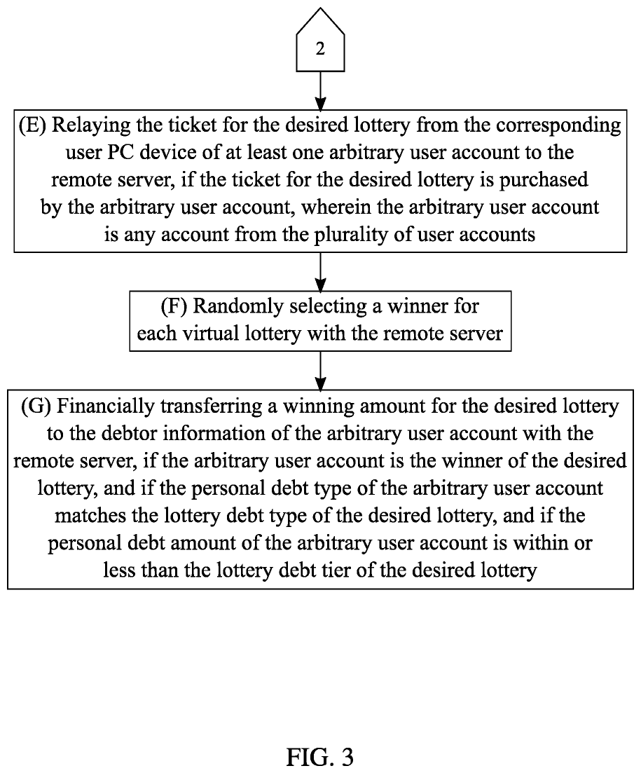

An overall process for the method of the present invention includes the following steps that are implemented with the at least one remote server and the plurality of user PC devices. As seen in FIG. 2, the overall process begins by enabling each user to navigate through the lottery debt type and the lottery debt tier of each virtual lottery with the corresponding PC device (Step C). This allows the user account to look through a catalog of available virtual lotteries that correspond with at least one personal debt amount. In order to be considered as part of a virtual lottery, each user account is prompted to purchase at least one ticket for at least one desired lottery with the corresponding user PC device (Step D). More specifically, the desired lottery is from the plurality of virtual lotteries such that the desired lottery corresponds with at least one debt profile. The ticket for the desired lottery is then relayed from the corresponding user PC device of at least one arbitrary account to the remote server, if the ticket for the desired lottery is purchased by the arbitrary user account (Step E), as seen in FIG. 3. The arbitrary user account is any account from the plurality of user accounts. This associates the ticket with a user account and the corresponding debt profile of the user account. A debt of the arbitrary user account is therefore paid off or partially paid off for the user account as a winner is randomly selected for each virtual lottery with the remote server (Step F). A winning amount for the desired lottery is financially transferred to the debtor information of the arbitrary user account with the remote server in accordance to certain conditions (Step G), thereby paying off a portion if not all of the personal debt amount of the corresponding debt profile and the arbitrary user account no longer needs to pay off or pay a significant amount of the corresponding debt profile. Moreover, the winning amount is only transferred to the debtor information of the arbitrary user account, if the arbitrary user account is the winner of the desired lottery, if the personal debt type of the arbitrary user account matches the lottery debt type of the desired lottery, and if the personal debt amount of the arbitrary user account is within or less than the lottery debt tier of the desired lottery. The virtual lottery therefore only accounts for the debt amount for a debt profile and does not provide additional money for the user account to spend as desired. Furthermore, if the debt type is that of a rental property and the creditor is a lessor, the lessor preferably requires a verification of employment, proof of income, or a verifiable secondary lessee prior to lease approval for the user account in order for the winning amount to be applied to the debt amount. The lessee also does not have to currently owe the lessor for a given duration of time in order to purchase a ticket in a lottery tier to win the stipulated number of months for an allowable lease. In the preferred embodiment of the present invention, a payment-processor account manages the financial transfer of the winning amount to the debtor information. The payment-processor account may electronically manage the financial transfer or prompt a check to be printed and then delivered to an address associated with the debtor information for the user account.

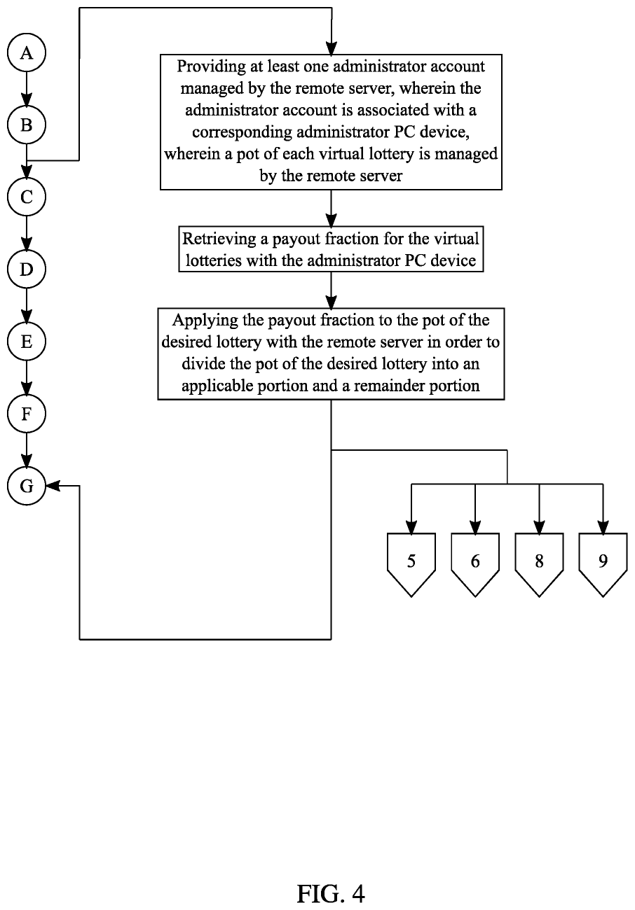

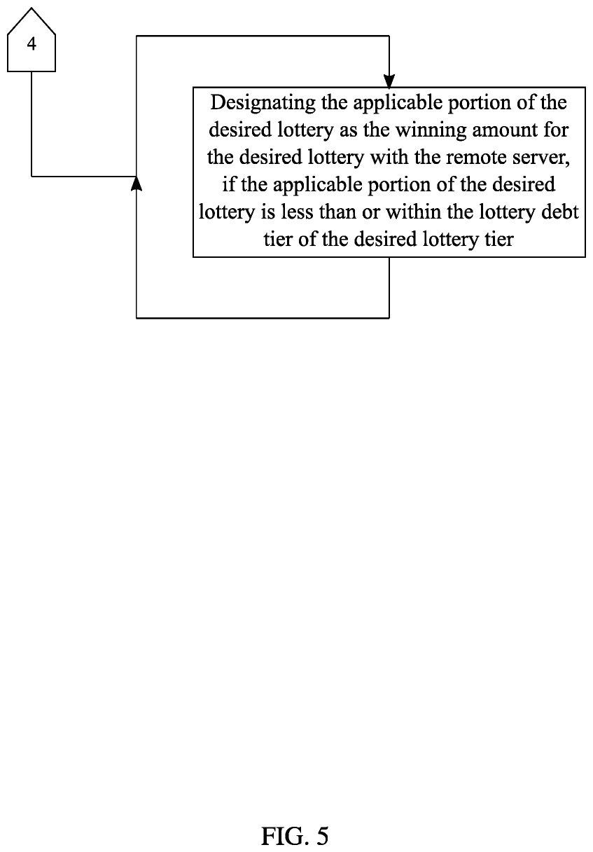

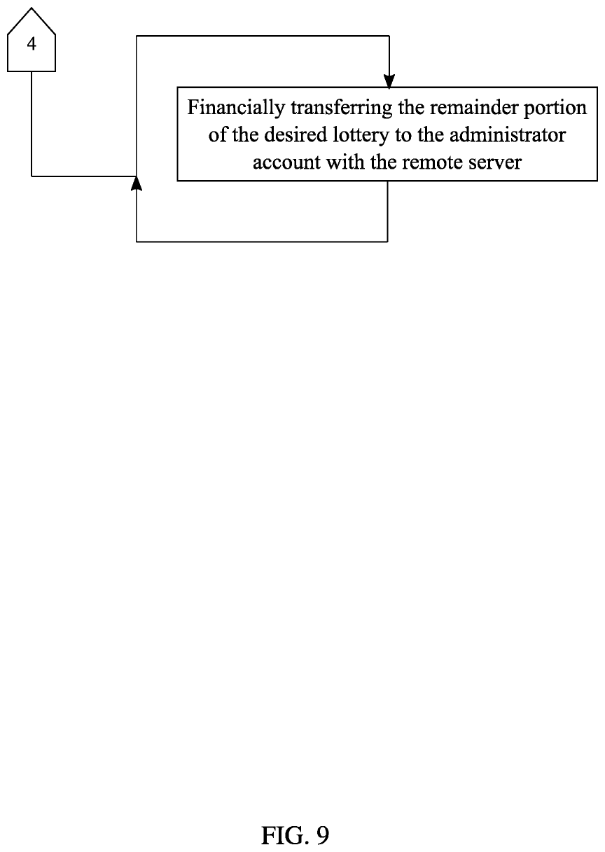

In order to manage the plurality of virtual lotteries and any investors that provide financial compensation for the winning amount of each virtual lottery, at least one administrator account that is managed by the remote server is provided, as seen in FIG. 4. The administrator account can be, but is not limited to, a lottery supplier, a designated operator of a government agency, or a government agency in charge of lottery and games that distributes the winning amount for each virtual lottery. More specifically, the administrator account is associated with a corresponding administrator PC device. A pot of each virtual lottery is managed by the remote server and the total monetary value of the purchased tickets. In order for the administrator account to maintain a revenue with the total amount of tickets purchased for each virtual lottery, a payout fraction for the virtual lotteries is retrieved with the administrator PC device. The payout fraction is applied to the pot of the desired lottery with the remote server in order to divide the pot of the desired lottery into an applicable portion and a remainder portion. The applicable portion is the percentage of the pot that pays off the debt amount of a corresponding debt profile for the user account. The remainder portion is the revenue gain for the administrator account. In order for the user account to receive the applicable portion, the applicable portion of the desired lottery is designated as the winning amount for the desired lottery with the remote server, if the applicable portion of the desired lottery is less than or within the lottery debt tier of the desired lottery tier, as seen in FIG. 5. The administrator account receives any revenue gain as the remainder portion of the desired lottery is financially transferred to the administrator account with the remote server, as seen in FIG. 9.

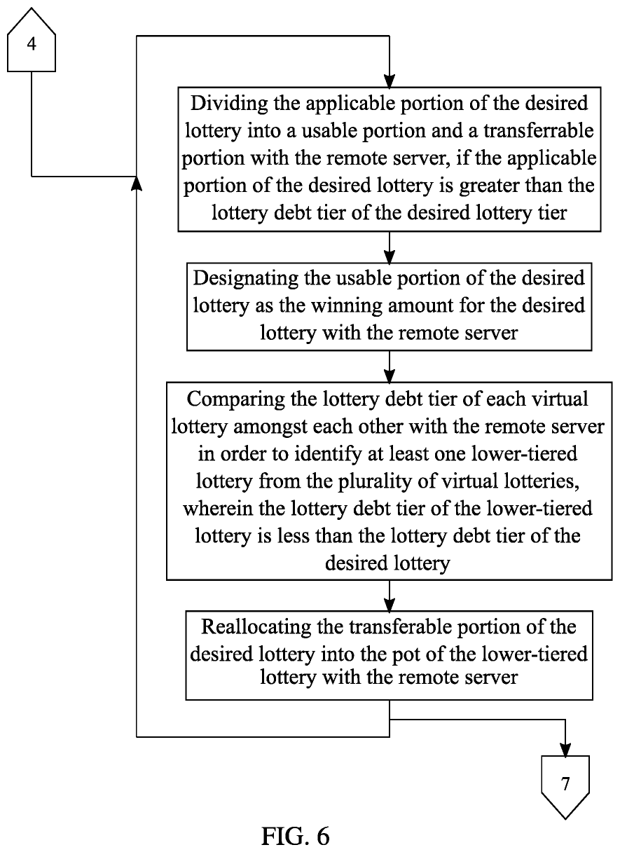

For some virtual lotteries it may be the case that a large amount of tickets is purchased for a specific lottery type and lottery tier that the applicable portion exceeds that of the lottery debt tier. As seen in FIG. 6, the applicable portion of the desired lottery is then divided into a usable portion and a transferrable portion with the remote server, if the applicable portion of the desired lottery is greater than the lottery debt tier of the desired lottery tier. The debt amount of the corresponding debt profile for the winner is paid off as the usable portion of the desired lottery is designated as the winning amount for the desired lottery with the remote server. The transferrable portion is distributed accordingly as the lottery debt tier of each virtual lottery is compared amongst each other with the remote server in order to identify at least one lower-tiered from the plurality of virtual lotteries, wherein the lottery debt tier of the lower-tiered lottery is less than the lottery debt tier of the desired lottery. The transferrable portion of the desired lottery is then reallocated into the pot of the lower-tiered lottery with the remote server in order to for the pot of each lower-tiered lottery tier to fulfill the usable portion and completely pay off the debt amount.

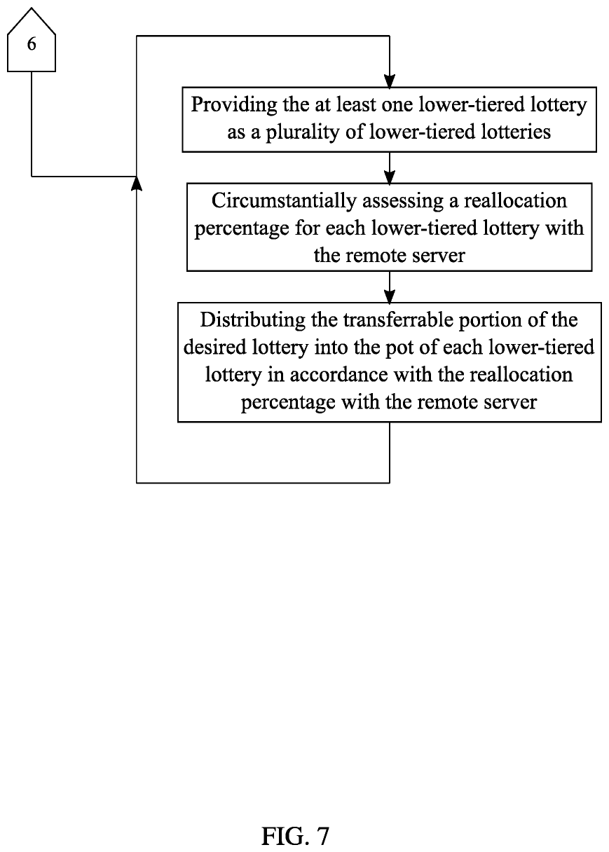

Furthermore, the at least one lower-tiered lottery is provided as a plurality of lower-tiered lotteries if multiple virtual lotteries have a lottery debt tier that is lower than that of the desired lottery tier of the desired lottery, as seen in FIG. 7. A reallocation percentage is circumstantially assessed for each lower-tiered lottery with the remote server. The reallocation percentage represents how much of the transferrable portion is given to each lower-tiered lottery, and is preferably based on a variety of factors such as the monetary value of each lower-tiered lottery, the number of players in each lower-tiered lottery, the total average debt amount of the plurality of user accounts associated with each lower-tiered lottery, and so on. The transferrable portion of the desired lottery is then distributed into the pot of each lower-tiered lottery in accordance with the reallocation percentage with the remote server in order to prioritize among the lower-tiered lottery for a winner.

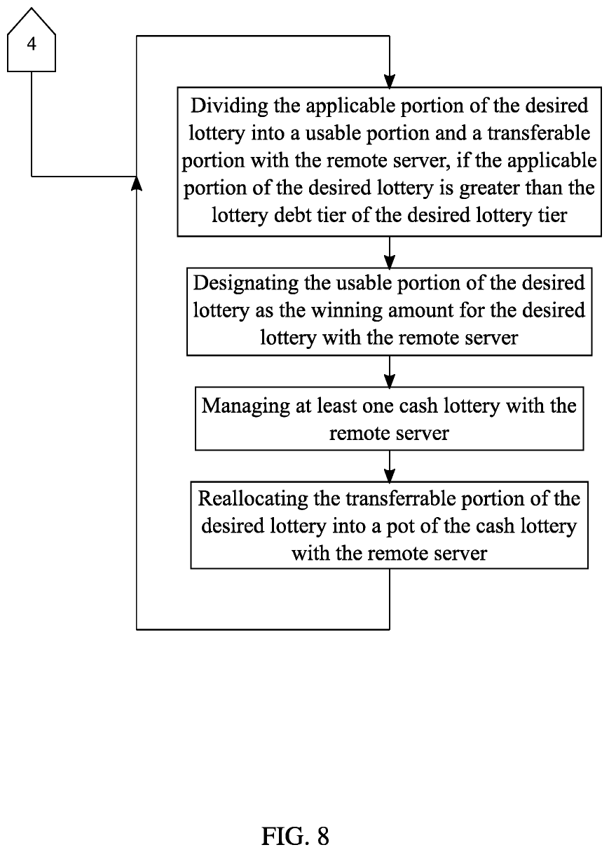

In an alternate embodiment of the present invention, the plurality of user accounts associated with a desired lottery that is not designated as the winner may receive a cash prize, as seen in FIG. 8. The applicable portion of the desired lottery is similarly divided into a usable portion and a transferrable portion with the remote server, if the applicable portion of the desired lottery is greater than the lottery debt tier of the desired lottery tier. The usable portion of the desired lottery is designated as the winning amount for the desired lottery with the remote server. At least one cash lottery is managed with the remote server in order to select another winner for the cash prize among the remaining plurality of user accounts associated with the desired lottery. The transferrable portion of the desired lottery is reallocated into a pot of the cash lottery with the remote server, and the pot of the cash lottery preferably being smaller in value than that of the applicable portion.

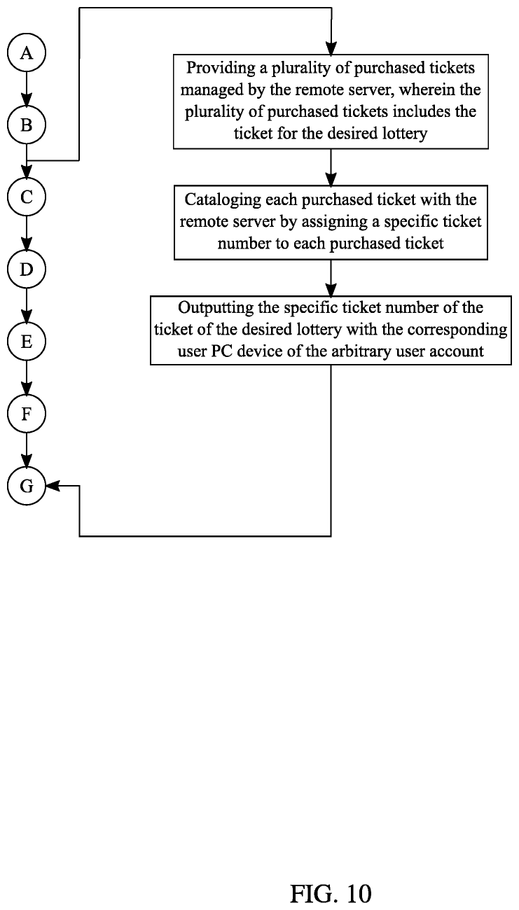

As user accounts purchase multiple tickets per debt type of each debt profile, a plurality of purchased tickets is provided and managed by the remote server, as seen in FIG. 10. The plurality of purchased tickets includes the ticket for the desired lottery, and each purchased ticket preferably includes a ticket identification number, a time stamp of purchase, drawing date information for the desired lottery, and so on. Each purchased ticked is cataloged with the remote server by assigning a specific ticket number to each purchased ticket, thereby associating and registering each ticket purchased for each debt profile. The specific ticket number differentiates each ticket purchased by a user account among any other tickets purchased by the same user account for the same desired lottery, as well as each ticket of other user accounts associated with the desired lottery. The specific ticket number of the ticket of the desired lottery is outputted with the corresponding user PC device of the arbitrary user account so that the user account can view and record the specific ticket number.

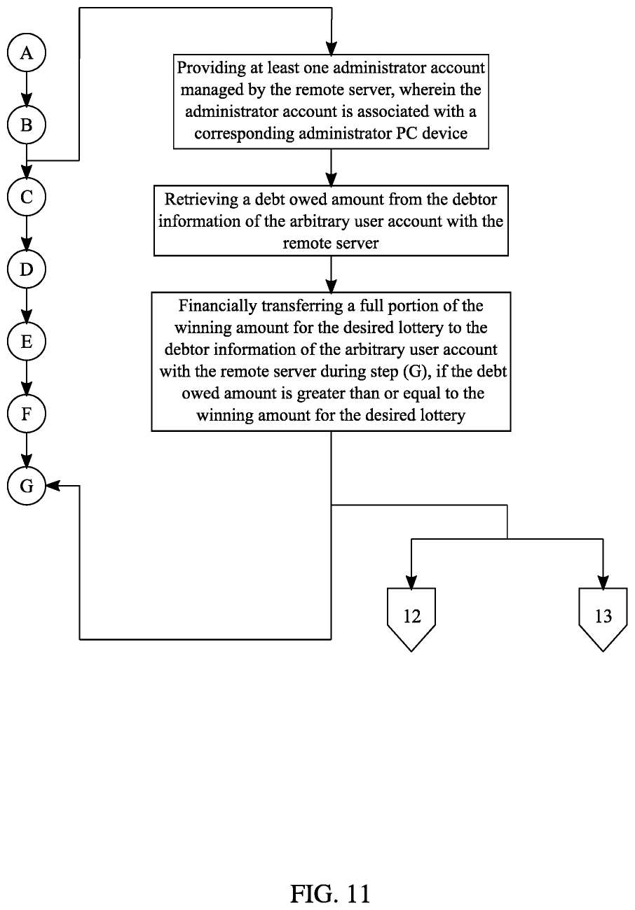

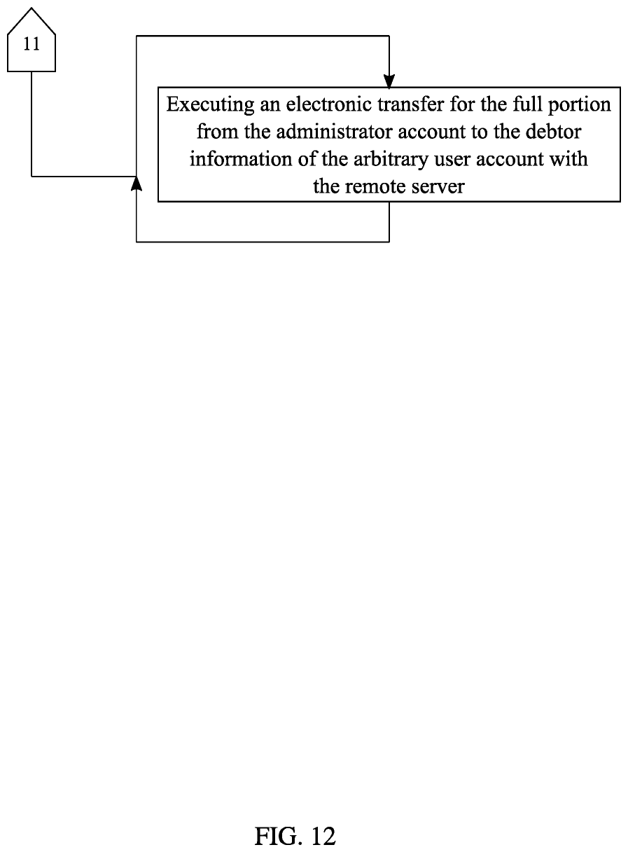

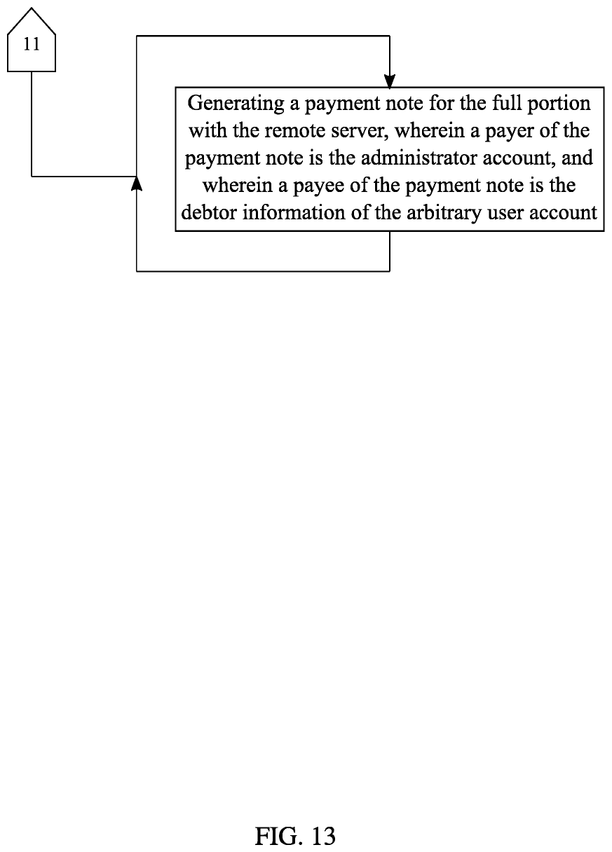

In order for the at least one administrator account to pay off the debt amount of the debt profile for the winner with the debtor information, a debt owed amount is retrieved from the debtor information of the arbitrary user account with the remote server, as seen in FIG. 11. This allows the at least one administrator to both verify the debt owed amount and compare the winning amount with the debt owed amount. A full portion of the winning amount for the desired lottery is then financially transferred to the debtor information of the arbitrary user account with the remote server during Step G, if the debt owed amount is greater than or equal to the winning amount for the desired lottery, thereby paying off a portion of the debt amount. The full portion accounts only for the winning amount such that the administrator account does not receive a remainder portion. An electronic transfer is executed for the full portion from the administrator account to the debtor information of the arbitrary user account with the remote server so that the administrator account may wirelessly transfer the winning amount to the debtor information, as seen in FIG. 12. Alternative to the electronic transfer, a payment note for the full portion is generated with the remote server, as seen in FIG. 13. The payment note is a physical check or comparable physical payment that serves as an alternative to the electronic transfer of the winning amount. The payment note is processed after the electronic transfer to serve as a receipt or confirmation for both the debtor information and the administrator account. More specifically, a payer of the payment note is the administrator account, and a payee of the payment note is the debtor information of the arbitrary user account. The payment note is processed and printed in order for the arbitrary user account to receive the payment note in the mail.

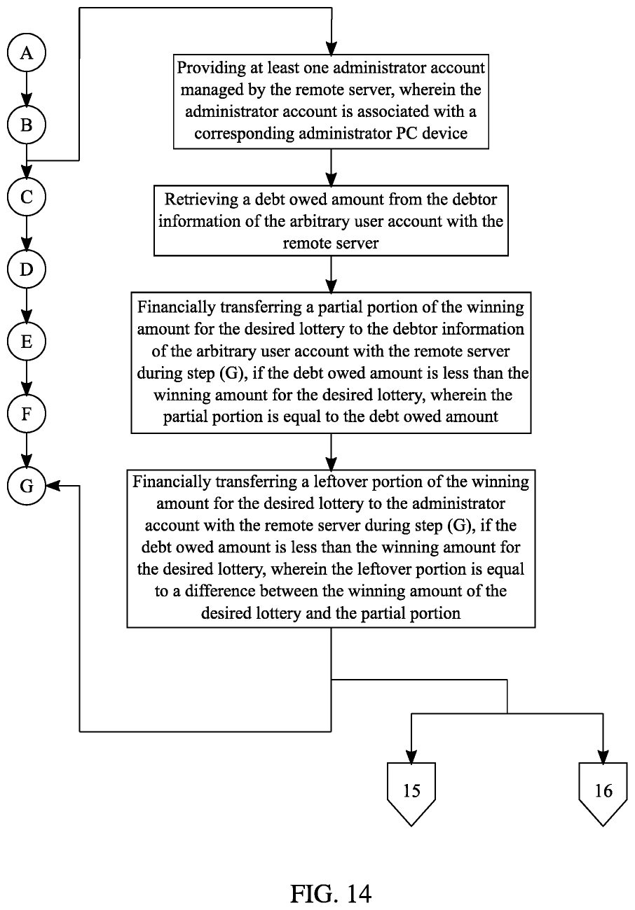

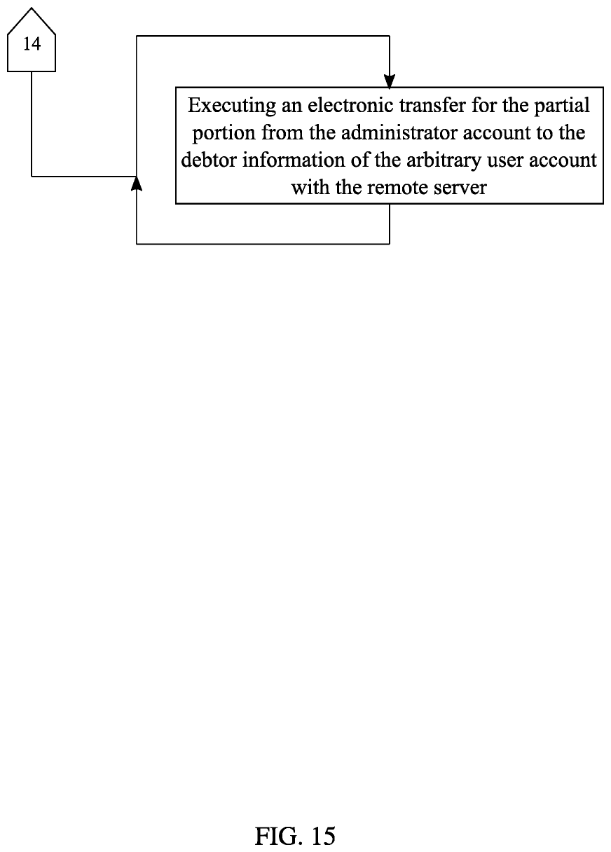

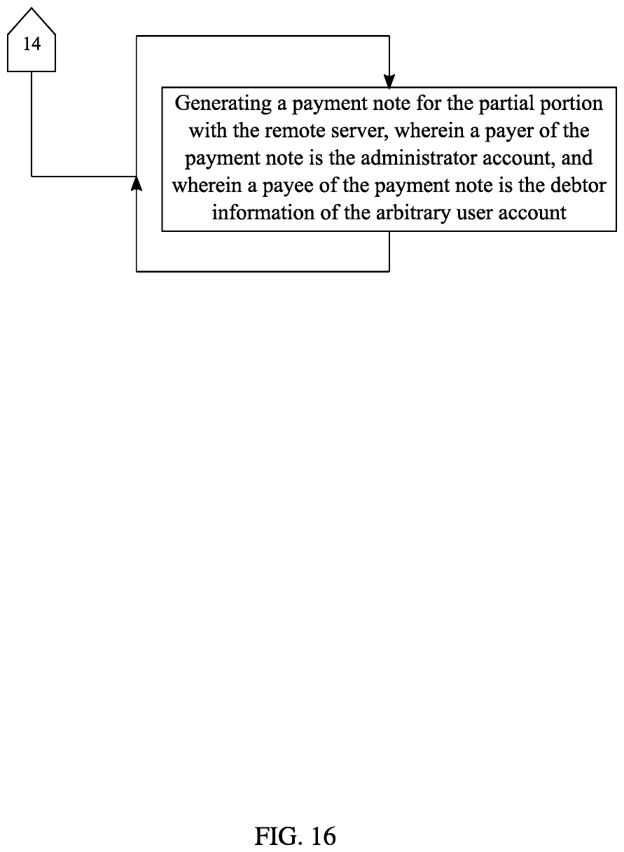

In the event that not enough tickets are not purchased for the virtual lottery, the administrator account pays off only a portion of the debt amount of the debt profile. As seen in FIG. 14, a partial portion of the winning amount for the desired lottery is financially transferred to the debtor information of the arbitrary user account with the remote server during Step G. The partial portion accounts for the entire debt amount as the debt owned amount is within the range of the lottery debt tier of the desired lottery. Moreover, the partial portion is only transferred if the debt owed amount is less than the winning amount for the desired lottery and, the partial portion is equal to the debt owed amount. A leftover portion of the winning amount for the desired lottery is financially transferred to the administrator account with the remote server during Step G, if the debt owed amount is less than the winning amount for the desired lottery, so that the administrator account is able to receive revenue gain with this financial transaction. Moreover, the leftover portion is equal to a difference between the winning amount of the desired lottery and the partial portion. An electronic transfer for the partial portion is executed from the administrator account to the debtor information of the arbitrary user account with the remote server so that the administrator account may wirelessly transfer funds to the debtor information, as seen in FIG. 15. A payment note for the partial portion is generated with the remote server, as seen in FIG. 16. The payment note is a physical check or comparable physical payment that serves as an alternative to the electronic transfer of the winning amount. The payment note is processed after the electronic transfer to serve as a receipt or confirmation for both the debtor information and the administrator account. Likewise, a payer of the payment note is the administrator account. A payee of the payment note is the debtor information of the arbitrary user account. The payment note is processed and printed in order for the arbitrary user account to receive the payment note in the mail.

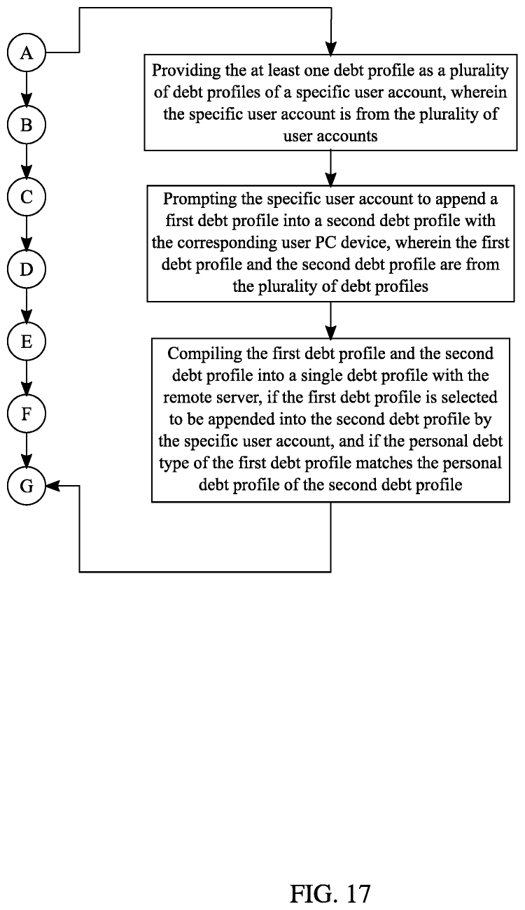

In order to facilitate the purchase of tickets of a desired lottery for the user account, the at least one debt profile is provided as a plurality of debt profiles of a specific user account, as seen in FIG. 17. More specifically, the specific user account is from the plurality of user accounts. The plurality of debt profiles may have different processing dates and varied debt amounts, but some of the debt profiles have the same debt type. The specific user account may facilitate the process of paying off multiple debt profiles with the same debt type as the specific user account is prompted to append a first debt profile into a second debt profile with the corresponding user PC device, wherein first debt profile and the second debt profile are from the plurality of debt profiles. In order to consolidate the first debt profile and the second debt profile, the first debt profile and the second debt profile are compiled into a single debt profile with the remote server. This consolidation may only occur if the first debt profile is selected to be appended into the second debt profile by the specific user account, and if the personal debt type of the first debt profile matches the personal debt profile of the second debt profile. The consolidation of the first debt profile and the second debt profile not only allows the specific user account to purchase less tickets in order to pay off the debt amount of the single debt profile, but allows the specific user to purchase a ticket of high lottery debt tier than that of the first debt profile and that of the second debt profile.

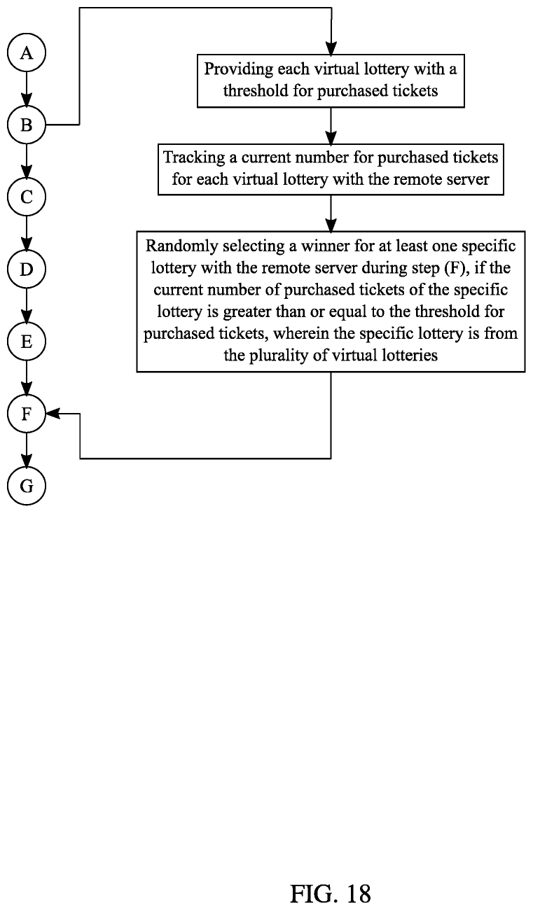

As each user account has options per debt type and debt tier, each virtual lottery must ensure a given amount of tickets purchased for each virtual lottery in order to be able to financially transfer the winning amount. Each virtual lottery is provided with a threshold for purchased tickets, which is a minimum amount of tickets purchased in order to proceed with a drawing for the virtual lottery, as seen in FIG. 18. A current number for purchased tickets for each virtual lottery is tracked with the remote server in order to be able to monitor the threshold for purchased tickets. A winner is then randomly selected for at least one specific lottery with the remote server during Step F, if the current number of purchased tickets of the specific lottery is greater than or equal to the threshold for the purchased tickets, wherein the specific lottery is from the plurality of virtual lotteries. A significant amount of the debt amount or the entire amount of the debt amount for the winner is guaranteed to be paid once the threshold for the purchased tickets is met.

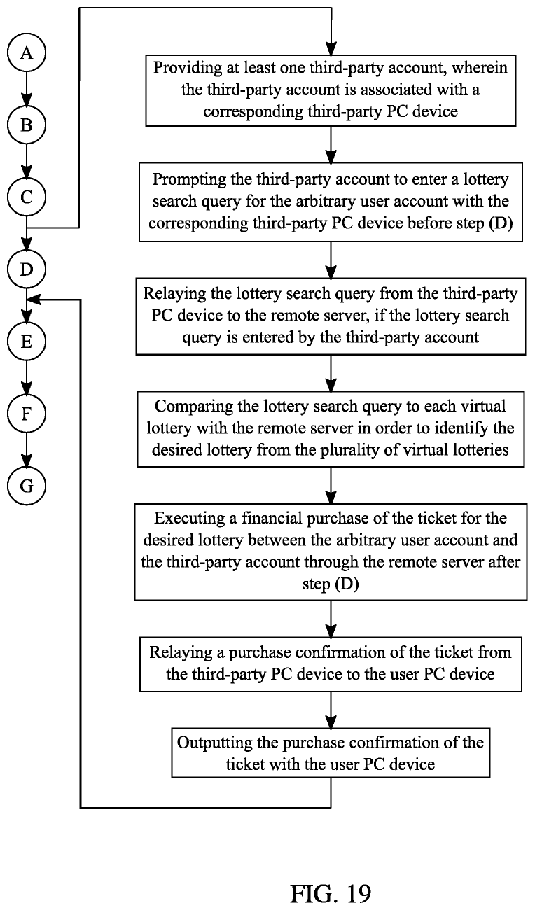

In order to aid the user account, at least one third-party account is provided, wherein the third-party account is associated with a corresponding third-party PC device, as seen in FIG. 19. Moreover, the third-party account is preferably used by a lottery retailer or lottery agent. The third-party account is prompted to enter a lottery search query for the arbitrary user account with the corresponding third-party PC device before Step D in order to provide the user account with a recommendation before a ticket is purchased by the user account. The lottery search query is relayed from the third-party PC device to the remote server, if the lottery search query is entered by the third-party account. Subsequently, the lottery search query is compared to each virtual lottery with the remote server in order to identify the desired lottery from the plurality of virtual lotteries. The user account is able to remotely message with the third-party account to view and analyze the recommendation of the third-party account. A financial purchase of the ticket for the desired lottery is then executed through the remote server after Step D. The financial purchase registers the user account with the desired lottery in order for the user account to be a possible winner. A purchase confirmation of the ticket from the third-party PC device is relayed to the user PC device, and the purchase confirmation of the ticket is outputted with the user PC device, so that the user account may view the purchase from the third-party account. The purchase confirmation of the ticket may then be printed with a printer for the physical records of the user account.

Although the invention has been explained in relation to its preferred embodiment, it is to be understood that many other possible modifications and variations can be made without departing from the spirit and scope of the invention as hereinafter claimed

What is claimed is:

1. A method of paying off debt through a lottery, the method comprises the steps:
(A) providing a plurality of user account managed by at least one remote server, wherein each user account is associated with a corresponding user personal computing (PC) device, and wherein each user account includes at least one debt profile, and wherein the debt profile includes a debtor information, a personal debt type, and a personal debt amount;
(B) providing a plurality of virtual lotteries managed by the remote server, wherein each virtual lottery includes a lottery debt type and a lottery debt tier;
(C) enabling each user account to navigate through the lottery debt type and the lottery debt tier of each virtual lottery with the corresponding user PC device;
(D) prompting each user account to purchase at least one ticket for at least one desired lottery with the corresponding user PC device, wherein the desired lottery is from the plurality of virtual lotteries;
(E) relaying the ticket for the desired lottery from the corresponding user PC device of at least one arbitrary user account to the remote server, if the ticket for the desired lottery is purchased by the arbitrary user account, wherein the arbitrary user account is any account from the plurality of user accounts;
(F) randomly selecting a winner for each virtual lottery with the remote server; and,
(G) financially transferring a winning amount for the desired lottery to the debtor information of the arbitrary user account with the remote server, if the arbitrary user account is the winner of the desired lottery, and if the personal debt type of the arbitrary user account matches the lottery debt type of the desired lottery, and if the personal debt amount of the arbitrary user account is within or less than the lottery debt tier of the desired lottery.

2. The method of paying off debt through a lottery, the method as claimed in claim 1 comprises the steps:
providing at least one administrator account managed by the remote server, wherein the administrator account is associated with a corresponding administrator PC device, wherein a pot of each virtual lottery is managed by the remote server;
retrieving a payout fraction for the virtual lotteries with the administrator PC device; and,
applying the payout fraction to the pot of the desired lottery with the remote server in order to divide the pot of the desired lottery into an applicable portion and a remainder portion.

3. The method of paying off debt through a lottery, the method as claimed in claim 2 comprises the step:
designating the applicable portion of the desired lottery as the winning amount for the desired lottery with the remote server, if the applicable portion of the desired lottery is less than or within the lottery debt tier of the desired lottery tier.

4. The method of paying off debt through a lottery, the method as claimed in claim 2 comprises the steps:
dividing the applicable portion of the desired lottery into a usable portion and a transferrable portion with the remote server, if the applicable portion of the desired lottery is greater than the lottery debt tier of the desired lottery tier;
designating the usable portion of the desired lottery as the winning amount for the desired lottery with the remote server;
comparing the lottery debt tier of each virtual lottery amongst each other with the remote server in order to identify at least one lower-tiered lottery from the plurality of virtual lotteries, wherein the lottery debt tier of the lower-tiered lottery is less than the lottery debt tier of the desired lottery; and,
reallocating the transferrable portion of the desired lottery into the pot of the lower-tiered lottery with the remote server.

5. The method of paying off debt through a lottery, the method as claimed in claim 4 comprises the steps:
providing the at least one lower-tiered lottery as a plurality of lower-tiered lotteries;
circumstantially assessing a reallocation percentage for each lower-tiered lottery with the remote server; and,
distributing the transferrable portion of the desired lottery into the pot of each lower-tiered lottery in accordance with the reallocation percentage with the remote server.

6. The method of paying off debt through a lottery, the method as claimed in claim 2 comprises the steps:
dividing the applicable portion of the desired lottery into a usable portion and a transferrable portion with the remote server, if the applicable portion of the desired lottery is greater than the lottery debt tier of the desired lottery tier;
designating the usable portion of the desired lottery as the winning amount for the desired lottery with the remote server;
managing at least one cash lottery with the remote server; and,
reallocating the transferrable portion of the desired lottery into a pot of the cash lottery with the remote server.

7. The method of paying off debt through a lottery, the method as claimed in claim 2 comprises the step:
financially transferring the remainder portion of the desired lottery to the administrator account with the remote server.

8. The method of paying off debt through a lottery, the method as claimed in claim 1 comprises the steps:
providing a plurality of purchased tickets managed by the remote server, wherein the plurality of purchased tickets includes the ticket for the desired lottery;
cataloging each purchased ticket with the remote server by assigning a specific ticket number to each purchased ticket; and,
outputting the specific ticket number of the ticket of the desired lottery with the corresponding user PC device of the arbitrary user account.

9. The method of paying off debt through a lottery, the method as claimed in claim 1 comprises the steps:
providing at least one administrator account managed by the remote server, wherein the administrator account is associated with a corresponding administrator PC device;
retrieving a debt owed amount from the debtor information of the arbitrary user account with the remote server; and,
financially transferring a full portion of the winning amount for the desired lottery to the debtor information of the arbitrary user account with the remote server during step (G), if the debt owed amount is greater than or equal to the winning amount for the desired lottery.

10. The method of paying off debt through a lottery, the method as claimed in claim 9 comprises the step:
executing an electronic transfer for the full portion from the administrator account to the debtor information of the arbitrary user account with the remote server.

11. The method of paying off debt through a lottery, the method as claimed in claim 9 comprises the step:
generating a payment note for the full portion with the remote server, wherein a payer of the payment note is the administrator account, and wherein a payee of the payment note is the debtor information of the arbitrary user account.

12. The method of paying off debt through a lottery, the method as claimed in claim 1 comprises the steps:
providing at least one administrator account managed by the remote server, wherein the administrator account is associated with a corresponding administrator PC device;
retrieving a debt owed amount from the debtor information of the arbitrary user account with the remote server;
financially transferring a partial portion of the winning amount for the desired lottery to the debtor information of the arbitrary user account with the remote server during step (G), if the debt owed amount is less than the winning amount for the desired lottery, wherein the partial portion is equal to the debt owed amount; and,
financially transferring a leftover portion of the winning amount for the desired lottery to the administrator account with the remote server during step (G), if the debt owed amount is less than the winning amount for the desired lottery, wherein the leftover portion is equal to a difference between the winning amount of the desired lottery and the partial portion.

13. The method of paying off debt through a lottery, the method as claimed in claim 12 comprises the step:
executing an electronic transfer for the partial portion from the administrator account to the debtor information of the arbitrary user account with the remote server.

14. The method of paying off debt through a lottery, the method as claimed in claim 12 comprises the step:
generating a payment note for the partial portion with the remote server, wherein a payer of the payment note is the administrator account, and wherein a payee of the payment note is the debtor information of the arbitrary user account.

15. The method of paying off debt through a lottery, the method as claimed in claim 1 comprises the steps:
providing the at least one debt profile as a plurality of debt profiles of a specific user account, wherein the specific user account is from the plurality of user accounts;
prompting the specific user account to append a first debt profile into a second debt profile with the corresponding user PC device, wherein the first debt profile and the second debt profile are from the plurality of debt profiles; and,
compiling the first debt profile and the second debt profile into a single debt profile with the remote server, if the first debt profile is selected to be appended into the second debt profile by the specific user account, and if the personal debt type of the first debt profile matches the personal debt profile of the second debt profile.

16. The method of paying off debt through a lottery, the method as claimed in claim 1 comprises the steps:
providing each virtual lottery with a threshold for purchased tickets;
tracking a current number for purchased tickets for each virtual lottery with the remote server; and,
randomly selecting a winner for at least one specific lottery with the remote server during step (F), if the current number of purchased tickets of the specific lottery is greater than or equal to the threshold for purchased tickets, wherein the specific lottery is from the plurality of virtual lotteries.

17. The method of paying off debt through a lottery, the method as claimed in claim 1 comprises the steps:
providing at least one third-party account, wherein the third-party account is associated with a corresponding third-party PC device;
prompting the third-party account to enter a lottery search query for the arbitrary user account with the corresponding third-party PC device before step (D);
relaying the lottery search query from the third-party PC device to the remote server, if the lottery search query is entered by the third-party account;
comparing the lottery search query to each virtual lottery with the remote server in order to identify the desired lottery from the plurality of virtual lotteries;
executing a financial purchase of the ticket for the desired lottery between the arbitrary user account and the third-party account through the remote server after step (D);
relaying a purchase confirmation of the ticket from the third-party PC device to the user PC device; and,
outputting the purchase confirmation of the ticket with the user PC device.
